(19) United States
(12) Patent Application Publication
(10) Pub. No.: US 2025/0391195 A1
(43) Pub. Date: Dec. 25, 2025

(54) COMPUTER VISION-BASED INSPECTION RECORD RECOGNITION METHOD AND APPARATUS

(71) Applicants: HYUNDAI MOTOR COMPANY, Seoul (KR); Kia Corporation, Seoul (KR)

(72) Inventors: Ohhyun KWON, Hwaseong-si (KR); Minkooc WEE, Hwaseong-si (KR); Hun Jae RHEE, Hwaseong-si (KR); Seungkyu JO, Hwaseong-si (KR)

(21) Appl. No.: 18/955,293

(22) Filed: Nov. 21, 2024

(30) Foreign Application Priority Data
Jun. 19, 2024 (KR) 10-2024-0079641

(51) Int. Cl. G06V 30/414; G06V 10/22

(52) U.S. Cl. CPC G06V 30/414; G06V 10/22

(57) ABSTRACT

A computer vision-based inspection record recognition method includes: extracting a box region from an inspection record reference image; detecting, within the box region, one or more coordinates of an information recognition target region; converting a scale of a target inspection record to match a scale of the inspection record reference image; and recognizing, based on the one or more coordinates of the information recognition target region of the inspection record reference image, information corresponding to same coordinates within the target inspection record that has a same scale as the inspection record reference image.

### CROSS-REFERENCE TO RELATED APPLICATION

This application claims priority to and the benefit of Korean Patent Application No. 10-2024-0079641, filed on Jun. 19, 2024, the disclosure of which is incorporated herein by reference in its entirety.

### TECHNICAL FIELD

The present disclosure relates to a computer vision-based inspection record recognition method and apparatus.

### BACKGROUND

When designating a reference image-based target region for information recognition from a scanned image of a paint inspection record, an inspection record may be created during the process of checking for defects in production work in the factory. This record may be scanned, recognized, and then computerized. In some examples, when setting a target region for information recognition, all target region coordinates may be written in the configuration file based on the reference image.

In some examples, top, bottom, left, and right anchors on the paint inspection record may be used to match the size of the scanned image and reference image for information recognition (inference). There may be black rectangular anchors in the top left, top right, bottom right, and bottom left of the paint inspection record. In some cases, when the image subject to information recognition (inference) may be different in size from the reference image or have a different angle depending on the scanning situation, the method of finding and matching the anchor of each image may be used.

In such method, it may be difficult to manage the coordinate values of the information recognition target region. That is, the coordinate values of all information recognition target regions may be written in the configuration file, and if the reference image changes, all corresponding coordinate values may be changed to new values.

In addition, when the information recognition (inference) target image may be converted by using the anchor, there may be cases in which the affine conversion may not be used to cope with the conversion.

### SUMMARY

The present disclosure attempts to provide a computer vision-based inspection record recognition method and method capable of finding a region (cell) coordinate where a value to be recognized by using an image processing algorithm for reducing man-hours of managing coordinate values of inspection record information recognition target regions.

The present disclosure attempts to provide a computer vision-based inspection record recognition method and method capable of finding a vertically crossing point of outermost lines instead of an anchor and designate it as a reference point of conversion and use the perspective transformation.

A computer vision-based inspection record recognition method can include extracting a box region from an inspection record reference image, detecting a coordinate of an information recognition target region within the extracted box region, converting a scale of a target inspection record to match a scale of the inspection record reference image, and recognizing information provided in the information recognition target region corresponding to the coordinate within a final target inspection record within having the converted scale.

The extracting the box region can include generating a black-and-white image in which one of a boundary line portion and a background portion is black and the other is white from the inspection record reference image through an image binarization algorithm.

The extracting the box region can further include removing noise from the black-and-white image, and detecting at least one box region formed of the boundary line portion.

The detecting the at least one box region can include detecting a preset maximum number of box regions from a box region of a greatest size to a box region of a smallest size in a descending order based on a size of the box region.

The detecting the coordinate of the information recognition target region can include separating the extracted box region into an OCR region and an OMR region.

The detecting the coordinate of the information recognition target region can include extracting each of a horizontal line and a vertical line within the box region through a morphology operation.

The detecting the coordinate of the information recognition target region can further include combining the extracted horizontal line and the vertical line, and detecting a contour line of the information recognition target region by repeatedly performing the binarization and the morphology operation with respect to the combined horizontal and vertical lines.

The detecting the coordinate of the information recognition target region can further include detecting a plurality of rectangular regions having a boundary of the contour line as the information recognition target region.

The converting the scale of the target inspection record can include detecting a plurality of outermost lines of the inspection record reference image, and detecting crossing points where the outermost lines vertically cross as first reference points, and determining the scale of the inspection record reference image based on the first reference points.

The converting the scale of the target inspection record can further include detecting the plurality of outermost lines of the target inspection record, detecting crossing points where the outermost lines of the target inspection record vertically cross as second reference points, and converting the scale of the target inspection record into a same scale as the scale of the inspection record reference image through a perspective transformation based on the first reference points and the second reference points.

A computer vision-based inspection record recognizing apparatus can include an information recognition target region detection module configured to extract a box region from an inspection record reference image, and detect a coordinate of an information recognition target region within the extracted box region, a reference point detection module configured to detect a first reference point for determining a scale of the inspection record reference image and a second reference point for determining a scale of a target inspection record, respectively, a scale conversion module configured to convert the scale of the target inspection record to match the scale of the inspection record reference image based on the first reference point and the second reference point, and an information recognition module configured to recognize information provided in the information recognition target region corresponding to the coordinate within a final target inspection record within having the converted scale.

The information recognition target region detection module can be configured to generate a black-and-white image in which one of a boundary line portion and a background portion is black and the other is white from the inspection record reference image, through an image binarization algorithm.

The information recognition target region detection module can be configured to remove noise from the black-and-white image, and detect at least one box region formed of the boundary line portion.

The information recognition target region detection module can be configured to detect a preset maximum number of box regions from a box region of a greatest size to a box region of a smallest size in a descending order based on a size of the box region.

The information recognition target region detection module can be configured to separate the extracted box region into OCR region and an OMR region.

The information recognition target region detection module can be configured to extract each of a horizontal line and a vertical line within the box region through a morphology operation.

The information recognition target region detection module can be configured to detect a contour line of the information recognition target region by combining the extracted horizontal line and the extracted vertical line and repeatedly perform the binarization and the morphology operation with respect to the combined horizontal and vertical lines.

The information recognition target region detection module can be configured to detect a plurality of rectangular regions having a boundary of the contour line as the information recognition target region.

The reference point detection module can be configured to detect crossing points where outermost lines of the inspection record reference image vertically cross as first reference points, and detect crossing points where the outermost lines of the target inspection record vertically cross as second reference points.

The scale conversion module can be configured to convert the scale of the target inspection record into a same scale as the scale of the inspection record reference image through a perspective transformation based on the first reference points and the second reference points.

A computer vision-based inspection record recognition method and method according to an implementation finds a region (cell) coordinate where a value to be recognized by using an image processing algorithm for reducing man-hours of managing coordinate values of inspection record information recognition target regions, thereby not requiring the configuration file management.

Even if the reference image is changed, a computer vision-based inspection record recognition method and method according to an implementation can find the recognition target region by using an algorithm without any need to input a new coordinate value.

A computer vision-based inspection record recognition method and method according to an implementation finds a vertically crossing point of outermost lines instead of an anchor and designate it as a reference point of conversion and use the perspective transformation, and accordingly, the affine conversion that was used because of the anchor detection uncertainty is not necessarily used, thereby being capable of removing an unsolvable error during matching the inference image to the reference image.

### BRIEF DESCRIPTION OF THE DRAWINGS

FIG. 1 is a flowchart of a computer vision-based inspection record recognition method according to an implementation.

FIG. 2 is a flowchart of a computer vision-based inspection record recognition method performed through a computer vision-based inspection record recognizing apparatus according to an implementation.

FIG. 3 and FIG. 4 are drawings showing detecting an information recognition target region according to an implementation.

FIG. 5 are drawing showing converting a scale of a target inspection record according to an implementation.

FIG. 6 are drawing showing a final target inspection record according to an implementation.

FIG. 7 is a drawing for explaining a computing device according to an implementation.

### DETAILED DESCRIPTION

Implementations of the disclosure will be described more fully hereinafter with reference to the accompanying drawings such that a person skill in the art can easily implement the implementations. As those skilled in the art would realize, the described implementations can be modified in various different ways, all without departing from the spirit or scope of the present disclosure. In order to clarify the present disclosure, parts that are not related to the description will be omitted, and the same elements or equivalents are referred to with the same reference numerals throughout the specification.

Hereinafter, implementations of the present disclosure will be described with reference to the drawings.

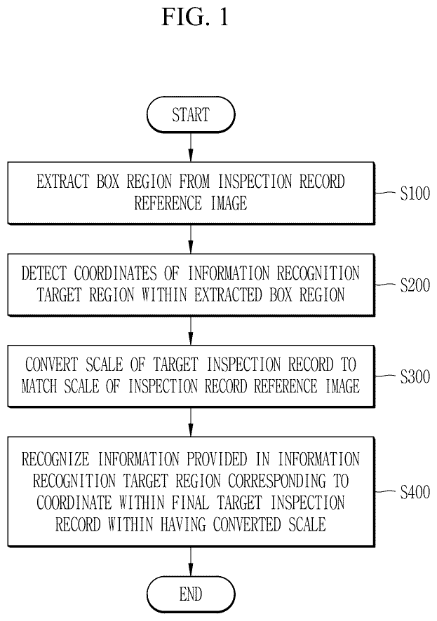

FIG. 1 is a flowchart of a computer vision-based inspection record recognition method according to an implementation.

In FIG. 1, at step S100, the computer vision-based inspection record recognition method can include extracting a box region from an inspection record reference image.

At step S200, the computer vision-based inspection record recognition method can include detecting coordinates of an information recognition target region within the extracted box region.

At step S300, the computer vision-based inspection record recognition method can include converting a scale of a target inspection record to match a scale of the inspection record reference image.

At step S400, the computer vision-based inspection record recognition method can include recognizing information provided in the information recognition target region corresponding to the coordinate within a final target inspection record within having the converted scale.

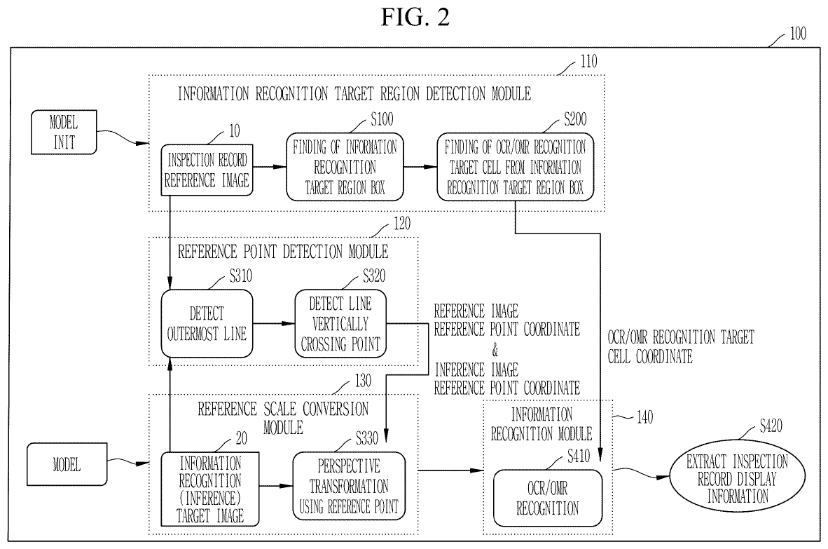

Steps of the computer vision-based inspection record recognition method according to an implementation of FIG. 1 can be performed through computer vision-based inspection record recognizing apparatus. Hereinafter, detailed description will be made with reference to FIG. 2 to FIG. 6.

FIG. 2 is a flowchart of the computer vision-based inspection record recognition method performed through a computer vision-based inspection record recognizing apparatus according to an implementation.

The computer vision-based inspection record recognition method of FIG. 2 can be performed by a computer vision-based inspection record recognizing apparatus 100.

Referring to FIG. 2, the computer vision-based inspection record recognizing apparatus 100 can include the information recognition target region detection module 110, a reference point detection module 120, a scale conversion module 130 and an information recognition module 140.

The information recognition target region detection module 110 can extract a box region from an inspection record reference image 10, and can detect coordinates of the information recognition target region within the extracted box region.

Here, the coordinate can include a location information. That is, the coordinate of the information recognition target region can mean a means for specifying the information recognition target region, but is not specifically limited.

The information recognition target region can be a regions including information, which is a target to be recognized in the image. The information recognition region can be a cell including information to be recognized.

At step S100, the information recognition target region detection module 110 can find a box region including the information recognition target region.

The information recognition target region detection module 110 can generate a black-and-white image in which one of a boundary line portion and a background portion is black and the other is white from the inspection record reference image 10 through an image binarization algorithm.

The information recognition target region detection module 110 can remove noise in the black-and-white image, and can detect at least one box region formed of the boundary line portions.

The information recognition target region detection module 110 can detect a preset maximum number of box regions from a box region of a greatest size to a box region of a smallest size in a descending order based on a size of the box region.

At step S200, the information recognition target region detection module 110 can find the information recognition target region cell including OCR/OMR recognition target, in the found box region.

The information recognition target region detection module 110 can separate the extracted box region into OCR region and OMR region.

The information recognition target region detection module 110 can extract each of a horizontal line and a vertical line within the box region through a morphology operation.

The information recognition target region detection module 110 can combine the extracted each of the horizontal line and the vertical line.

The information recognition target region detection module 110 can repeatedly perform binarization and the morphology operation with respect to the combined horizontal and vertical lines, and thereby can detect the contour line of the information recognition target region.

The information recognition target region detection module 110 can detect a plurality of rectangular regions having a boundary of the contour line as the information recognition target region.

The reference point detection module 120 can detect a first reference point for determining the scale of the inspection record reference image and a second reference point for determining the scale of the target inspection record, respectively.

At step S310, the reference point detection module 120 can detect an outermost line from the inspection record reference image 10 and the target inspection record (information recognition target image) 20, respectively.

At step S320, the reference point detection module 120 can detect the vertically crossing points of the detected outermost lines.

The reference point detection module 120 can detect crossing points where outermost lines of the inspection record reference image 10 vertically cross as the first reference points.

The reference point detection module 120 can detect crossing points where outermost lines of the target inspection record (information recognition target image) 20 vertically cross as the second reference points.

The reference point detection module 120 can detect a coordinate of each of the first reference points and the second reference points that are detected.

At step S330, the scale conversion module 130 can convert the scale of the target inspection record 20 to match the scale of the inspection record reference image 10 based on the first reference point and the second reference point.

At step S330, that is, the scale conversion module 130 can convert the scale of the target inspection record 20 into a same scale as the scale of the inspection record reference image 10 through a perspective transformation based on the first reference points and the second reference points.

The information recognition module 140 can recognize information provided in the information recognition target region corresponding to a coordinate of the recognition target cell within the final target inspection record within having the converted scale.

At step S410, the information recognition module 140 can recognize information provided in the information recognition target region through OCR/OMR.

At step S420, the computer vision-based inspection record recognizing apparatus 100 can extract display information of a final inspection record.

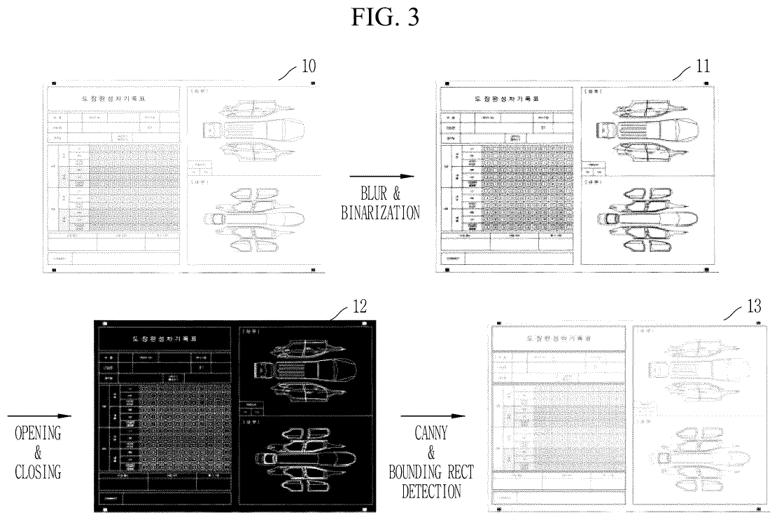

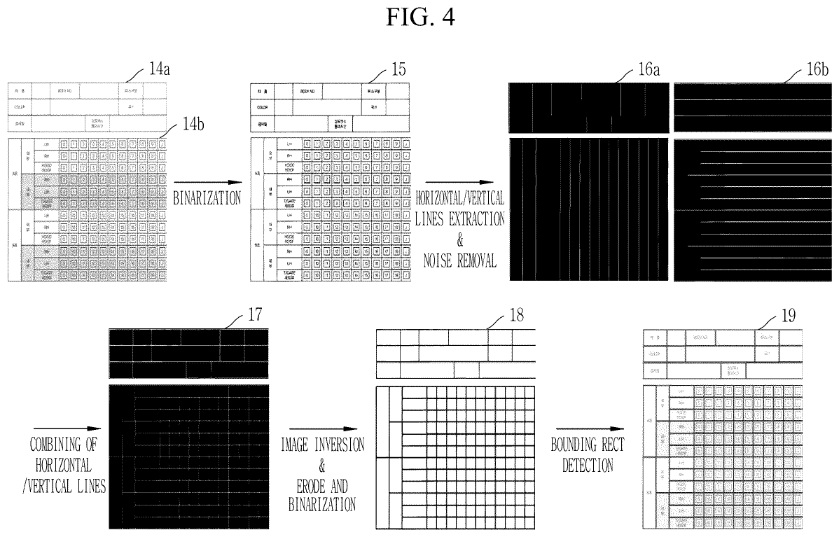

FIG. 3 and FIG. 4 are drawing showing the information recognition target region detection step according to an implementation.

FIG. 3 shows extracting of the box region.

In FIG. 3, the computer vision-based inspection record recognizing apparatus 100 can generate black-and-white images 11 and 12 in which one of the boundary line portion and the background portion is black and the other is white from the inspection record reference image 10, through the image binarization algorithm.

The computer vision-based inspection record recognizing apparatus 100 can convert the colored inspection record reference image 10 into black-and-white, and can remove basic noise by blur processing.

The computer vision-based inspection record recognizing apparatus 100 can binarize the inspection record reference image 10 into values of black and white by using an Otsu algorithm that binarizes the contrast distribution pixel by adjusting a threshold value.

The computer vision-based inspection record recognizing apparatus 100 can convert the boundary line portion that appears as a line to the white color value (RGB255), and a portion representing background to a black color value RGB0.

The computer vision-based inspection record recognizing apparatus 100 can repeatedly perform the opening/closing operations that remove noise while strengthening broken or thin portions of the line.

The computer vision-based inspection record recognizing apparatus 100 can remove noise in the black-and-white image 12, and can detect at least one box region formed of the boundary line portions.

The computer vision-based inspection record recognizing apparatus 100 can form a contour that displays an outer boundary line on a portion (box form) connected by lines by using a Canny edge detection operation.

The computer vision-based inspection record recognizing apparatus 100 can detect a bounding rectangle as a box region 13, with respect to the contour in which the outer boundary line is displayed in the box form.

The computer vision-based inspection record recognizing apparatus 100 can detect the preset maximum number of box regions from a box region of a greatest size to a box region of a smallest size in a descending order based on a size of the box region.

The computer vision-based inspection record recognizing apparatus 100 can set the number of maximum box regions that can be confirmed from the reference image by config, and can detect maximum number of rectangular box regions 13 that can be detected in a descending order from the great box.

FIG. 4 shows detecting of a coordinate of the information recognition target region.

In FIG. 4, the computer vision-based inspection record recognizing apparatus 100 can separate the extracted box region into an OCR region 14a and an OMR region 14b.

That is, the computer vision-based inspection record recognizing apparatus 100 can divide and cut an information recognition target box region found from the inspection record reference image 10 (see FIG. 2) into a portion 14a for which letters printed by OCR must be recognized and a portion 14b for which cells marked by OMR must be found.

The computer vision-based inspection record recognizing apparatus 100 can convert the colored inspection record reference image 10 into black-and-white and binarize a black-and-white image 15 having black and white values by using an Otsu algorithm.

The computer vision-based inspection record recognizing apparatus 100 can extract each of the horizontal line 16b and a vertical line 16a within the box region through the morphology operation.

That is, the computer vision-based inspection record recognizing apparatus 100 can extract images 16a and 16b of only the horizontal/vertical lines from the black-and-white image 15 of the inspection record reference image by using horizontal and/or vertical kernels.

The computer vision-based inspection record recognizing apparatus 100 can repeat opening operations (e.g., erode and dilate) to remove noise, and create the horizontal/vertical lines in the form of connected lines.

The computer vision-based inspection record recognizing apparatus 100 can combine the extracted horizontal and vertical lines (see 17).

The computer vision-based inspection record recognizing apparatus 100 can repeatedly perform binarization and the morphology operation with respect to the combined horizontal and vertical lines 17, and thereby can detect a contour a line 18 of the information recognition target region.

That is, the computer vision-based inspection record recognizing apparatus 100 can combine the above two horizontal/vertical images, and then can find a clear line 18 through performing the erode operation and the binarization process once more.

The computer vision-based inspection record recognizing apparatus 100 can detect the plurality of rectangular regions having a boundary of contour lines as the information recognition target region 19.

The computer vision-based inspection record recognizing apparatus 100 can find a contour form distinguished by lines, and can find a rectangle bounded by a contour of an internal cell form. At this time, the computer vision-based inspection record recognizing apparatus 100 can add a config setting so as to filter only the rectangle of an appropriate size.

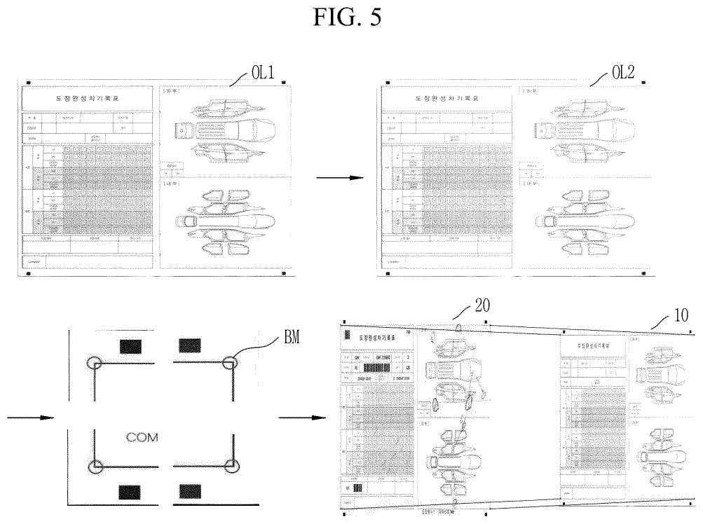

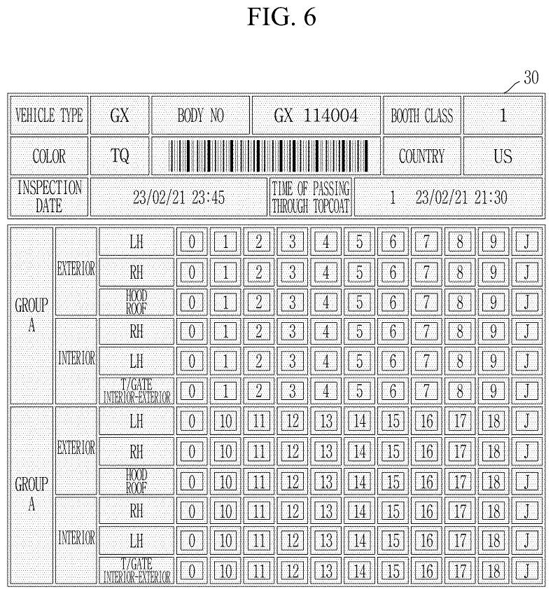

FIG. 5 are drawing showing converting the scale of the target inspection record according to an implementation. FIG. 6 are drawing showing the final target inspection record according to an implementation.

In FIG. 5, the computer vision-based inspection record recognizing apparatus 100 can detect a plurality of outermost lines of the inspection record reference image 10.

The computer vision-based inspection record recognizing apparatus 100 can detect crossing points where outermost lines vertically cross as the first reference points, and can determine a scale of the inspection record reference image 10 based on the first reference points.

The computer vision-based inspection record recognizing apparatus 100 can detect the plurality of outermost lines of the target inspection record 20.

The computer vision-based inspection record recognizing apparatus 100 can detect crossing points where the outermost lines of the target inspection record 20 vertically cross as the second reference points.

The first reference points and the second reference points can be detected in the dame method with respect to the inspection record reference image 10 and the target inspection record 20, respectively.

In an implementation, the computer vision-based inspection record recognizing apparatus 100 can detect an edge OL1 exceeding the threshold value through 1D Sobel filter operation starting from the outermost pixel line of each of top, bottom, left, and right sides of the inspection record reference image 10 and going down one line at a time.

The edge OL1 found first from the top, bottom, left, and right outermost side have a high possibility of being located on a line of an outermost box region of the inspection record reference image 10.

The computer vision-based inspection record recognizing apparatus 100 can detect an outermost line OL2 from which noise is removed by using the random sample consensus (RANSAC) based on the detected edge OL1.

The computer vision-based inspection record recognizing apparatus 100 can find the vertically crossing point by forming pairs of two vertical lines among the outermost lines OL2, after the outermost line OL2 of the outside box region in four sides of top, bottom, left, and right.

The computer vision-based inspection record recognizing apparatus 100 can set sub-windows centered at corresponding crossing points with respect to the found four vertically crossing points, respectively, and can determine final four reference points BM by adjusting precision of the crossing point by the sub-pixel unit.

The computer vision-based inspection record recognizing apparatus 100 can convert the scale of the target inspection record 20 into a same scale as the scale of the inspection record reference image 10 through the perspective transformation based on the first reference points and the second reference points.

The computer vision-based inspection record recognizing apparatus 100 can also find reference points for the information recognition (inference) target image (target inspection record) 20 by repeating the above process.

The computer vision-based inspection record recognizing apparatus 100 can generate a homography matrix with respect to the reference point BM of the inspection record reference image 10, and can convert the scale of the target inspection record 20 into the scale of the inspection record reference image 10 through the perspective transformation.

That is, the computer vision-based inspection record recognizing apparatus 100 can generate the final target inspection record 30 in which the target inspection record 20 is scaled with the inspection record reference image 10.

In FIG. 6, the computer vision-based inspection record recognizing apparatus 100 can perform the OCR/OMR recognition at a location corresponding to the coordinate of the information target recognition region (cell) previously found on the final target inspection record 20.

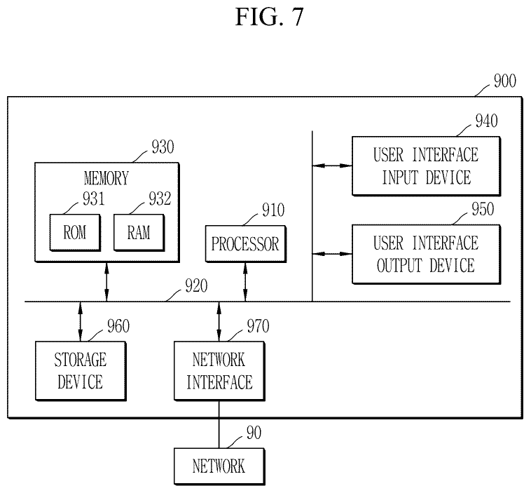

FIG. 7 is a drawing for explaining a computing device according to an implementation.

Referring to FIG. 7, the computer vision-based inspection record recognition method and apparatus according to implementations can be implemented by using a computing device 900.

The computing device 900 can include at least one of a processor 910, a memory 930, the user interface input device 940, the user interface output device 950 and a storage device 960 that communicate through a bus 920. The computing device 900 can also include a network interface 970 electrically connected to a network 90. The network interface 970 can transmit or receive signals with other entities through the network 90.

The processor 910 can be implemented in various types such as a micro controller unit (MCU), an application processor (AP), a central processing unit (CPU), a graphic processing unit (GPU), a neural processing unit (NPU), and the like, and can be any type of semiconductor device capable of executing instructions stored in the memory 930 or the storage device 960. The processor 910 can be configured to implement the functions and methods described above with respect to FIG. 1 to FIG. 6.

The memory 930 and the storage device 960 can include various types of volatile or non-volatile storage media. For example, the memory can include read-only memory (ROM) 931 and a random-access memory (RAM) 932. In this implementation, the memory 930 can be located inside or outside processor 910, and the memory 930 can be connected to the processor 910 through various known means.

In some implementations, at least some components or functions of a computer vision-based inspection record recognition method and method can be implemented as programs or software executed by the computing device 900, and the programs or software can be stored in a computer-readable medium.

In some implementations, at least some configurations or functions of a computer vision-based inspection record recognition method and method can be implemented by using hardware or circuitry of the computing device 900, or can also be implemented as separate hardware or circuitry that can be electrically connected to the computing device 900.

While this disclosure has been described in connection with what is presently considered to be practical implementations, it is to be understood that the disclosure is not limited to the disclosed implementations, but, on the contrary, is intended to cover various modifications and equivalent arrangements included within the spirit and scope of the appended claims

What is claimed is:

1. A computer vision-based inspection record recognition method, comprising:
extracting a box region from an inspection record reference image;
detecting, within the box region, one or more coordinates of an information recognition target region;
converting a scale of a target inspection record to match a scale of the inspection record reference image; and
recognizing, based on the one or more coordinates of the information recognition target region of the inspection record reference image, information corresponding to same coordinates within the target inspection record that has a same scale as the inspection record reference image.

2. The method of claim 1, wherein the inspection record reference image comprises a boundary line portion and a background portion, and
wherein extracting the box region comprises:
generating, based on an image binarization algorithm, a black-and-white image where (i) one of the boundary line portion or the background portion is black and (ii) the other of the boundary line portion or the background portion is white.

3. The method of claim 2, wherein extracting the box region comprises:
removing noise from the black-and-white image, and
detecting at least one box region at the boundary line portion.

4. The method of claim 3, wherein detecting the at least one box region comprises:
detecting, in descending order from a largest-sized box region to a smallest-sized box region, a preset maximum number of box regions.

5. The method of claim 1, wherein detecting the one or more coordinates of the information recognition target region comprises:
separating the box region into an Optical Character Recognition (OCR) region and an Optical Mark Recognition (OMR) region.

6. The method of claim 1, wherein detecting the one or more coordinates of the information recognition target region comprises:
extracting, based on a morphology operation, one or more horizontal lines and one or more vertical lines within the box region.

7. The method of claim 6, wherein detecting the one or more coordinates of the information recognition target region comprises:
combining the one or more horizontal lines and the one or more vertical lines, and
detecting a contour line of the information recognition target region by repeatedly performing a binarization and the morphology operation with respect to combined horizontal and vertical lines.

8. The method of claim 7, wherein the detecting the one or more coordinates of the information recognition target region comprises:
detecting a plurality of rectangular regions as the information recognition target region, and
wherein the plurality of rectangular regions have the contour line as a boundary of the rectangular regions.

9. The method of claim 1, wherein the converting the scale of the target inspection record comprises:
detecting a plurality of outermost lines of the inspection record reference image,
detecting, as first reference points, intersection points where the outermost lines vertically intersect, and
determining, based on the first reference points, the scale of the inspection record reference image.

10. The method of claim 9, wherein converting the scale of the target inspection record comprises:
detecting a plurality of outermost lines of the target inspection record,
detecting, as second reference points, intersection points where the outermost lines of the target inspection record vertically intersect, and
converting, based on (i) a perspective transformation, (ii) the first reference points and (iii) the second reference points, the scale of the target inspection record to match the scale of the inspection record reference image.

11. A computer vision-based inspection record recognizing apparatus, comprising:
an information recognition target region detection module configured to (i) extract a box region from an inspection record reference image and (ii) detect one or more coordinates of an information recognition target region within the box region;
a reference point detection module configured to detect (i) one or more first reference points for determining a scale of the inspection record reference image and (ii) one or more second reference points for determining a scale of a target inspection record;
a scale conversion module configured to, based on the one or more first reference points and the one or more second reference points, convert the scale of the target inspection record to match the scale of the inspection record reference image; and
an information recognition module configured to recognize, based on the one or more coordinates of the information recognition target region of the inspection record reference image, information corresponding to same coordinates within the target inspection record that has a same scale as the inspection record reference image.

12. The apparatus of claim 11, wherein the inspection record reference image comprises a boundary line portion and a background portion, and
wherein the information recognition target region detection module is configured to generate, based on an image binarization algorithm, a black-and-white image where (i) one of the boundary line portion or the background portion is black and (ii) the other of the boundary line portion or the background portion is white.

13. The apparatus of claim 12, wherein the information recognition target region detection module is configured to (i) remove noise from the black-and-white image and (ii) detect at least one box region at the boundary line portion.

14. The apparatus of claim 13, wherein the information recognition target region detection module is configured to, in descending order from a largest-sized box region to a smallest-sized box region, detect a preset maximum number of box regions.

15. The apparatus of claim 11, wherein the information recognition target region detection module is configured to separate the box region into an Optical Character Recognition (OCR) region and an Optical Mark Recognition (OMR) region.

16. The apparatus of claim 11, wherein the information recognition target region detection module is configured to, based on a morphology operation, extract one or more horizontal lines and one or more vertical lines within the box region.

17. The apparatus of claim 16, wherein the information recognition target region detection module is configured to:
combine the one or more horizontal lines and the one or more vertical lines, and
detect a contour line of the information recognition target region by repeatedly performing a binarization and the morphology operation with respect to combined horizontal and vertical lines.

18. The apparatus of claim 17, wherein the information recognition target region detection module is configured to detect a plurality of rectangular regions as the information recognition target region,
wherein the plurality of rectangular regions have the contour line as a boundary of the rectangular regions.

19. The apparatus of claim 11, wherein the reference point detection module is configured to:
detect, as first reference points, intersection points where outermost lines of the inspection record reference image vertically intersect; and
detect, as second reference points, intersection points where outermost lines of the target inspection record vertically intersect.

20. The apparatus of claim 19, wherein the scale conversion module is configured to, based on (i) a perspective transformation, (ii) the first reference points and (iii) the second reference points, convert the scale of the target inspection record to match the scale of the inspection record reference image.
